(19) United States
(12) Patent Application Publication
(10) Pub. No.: US 2006/0229208 A1
(43) Pub. Date: Oct. 12, 2006

(54) Use of acyl cyclohexandione derivatives in conjunction with ethephon for treating pomaceous fruit

(75) Inventor: Wilhelm Rademacher, Limburgerhof (DE)

Correspondence Address: ROTHWELL, FIGG, ERNST & MANBECK, P.C., 1425 K STREET, N.W., SUITE 800, WASHINGTON, DC, 20005, US

(73) Assignee: BASF AKTIENGESELLSCHAFT, LUDWIGSHAFEN (DE)

(21) Appl. No.: 10/567,467

(22) PCT Filed: Aug. 6, 2004
(86) PCT No.: PCT/EP04/08832

§ 371 Date: Feb. 7, 2006

(30) Foreign Application Priority Data
Aug. 8, 2003 (DE) 103 36 612.1

(51) Int. Cl. A01N 37/00

(52) U.S. Cl. 504/313

(57) ABSTRACT

The present invention relates to the use of acylcyclohexanedione derivatives together with ethephon for the treatment of pome fruit.

The present invention relates to the use of acylcyclohexanedione derivatives together with ethephon for the treatment of pome fruit.

Reducing excessive shoot growth by chemical means, i.e. the use of growth regulators, is desired in perennial fruit plantations since pruning costs can be avoided and crop protection measures can be made easier; moreover, light exposure inside the plantation can be improved.

Both acylcyclohexanedione derivatives and ethephon (2-chloroethylphosphonic acid) are known growth regulators. Thus, EP-A-123001 and EP-A-126713 describe the use of acylcyclohexanedione compounds of the formula 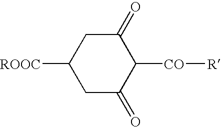
in which
R is hydrogen, alkyl, alkylthioalkyl or substituted or unsubstituted phenyl and
R′ is alkyl, substituted or unsubstituted benzyl, phenethyl, phenoxymethyl,
2-thienylmethyl, alkoxymethyl or alkylthiomethyl,
or their salts as growth regulators.

In J. Amer. Soc. Hort. Sci. 94, pp.11-14 (1969), L. J. Edgerton and W. J. Greenhalgh describe the growth-regulatory effect of ethephon on apples.

A disadvantage in the use of acylcyclohexanedione derivatives for the purposes of growth regulation which has emerged is that, in certain plants, floral development in the year after the treatment, and, as a consequence, also fruit development, is markedly reduced. Thus, D. Sugar, D. C. Elfving and E. A. Mielke report in Acta Hort. 596, pp. 757-760 (2002) that the treatment of pear trees with prohexadione-calcium leads to reduced subsequent flowering. Experiments carried out by the Applicant company have confirmed these results and demonstrated that acylcyclohexanedione-based growth regulators, in particular prohexadione-calcium and to a particularly high degree trinexapac, or trinexapac-ethyl, lead to markedly reduced floral development in pome fruit and specifically in apples and pears in the year after the treatment. In the most extreme case, no floral development at all takes place in the year after the treatment.

Not only does the treatment lead to reduced subsequent flowering, and frequently in association therewith, reduced yields in the year in question, but it may also trigger biennial bearing. Biennial bearing means that a year with unduly low yield is followed by a year with unduly high yield, usually of low quality. In perennial fruit crops such as pome fruit (apples, pears, quinces), stone fruit (sweet cherries, morello cherries, plums, quetsch, peaches, nectarines, apricots, almonds), soft fruit (gooseberries, currants, raspberries, blackberries), hard-shelled fruit (walnuts, hazelnuts, pecan nuts, pistachios), citrus fruits (oranges, grapefruits, mandarins, lemons), grapevines, figs, khaki plums, kiwi fruits, avocados, mangoes, lychees, dates and also coffee and cocoa, however, prolonged constant yield is an essential economical factor so that variations in terms of quantity and quality of the products must be avoided as much as possible. Accordingly, biennial bearing induced by chemical growth regulators is economically unacceptable.

In HortScience 38 (2), pp. 293-298 (2003), D. C. Elfving, G. A. Lang and D. B. Visser describe that, in certain cherry varieties, treatment of the trees with a combination of prohexadione-calcium and ethephon leads to increased floral density combined with reduced vegetative growth. However, reduced flowering in the year following the treatment with prohexadione-calcium alone is not reported.

It is an object of the present invention to provide a growth-regulatory composition for the treatment of pome fruit which reduces the vegetative growth while simultaneously not substantially reducing floral development after the treatment.

Surprisingly, it has been found that ethephon prevents the phenomenon of reduced floral development which is found after pome fruit has been treated with certain acylcyclohexanedione derivatives. It has been found that this object can be achieved by the concomitant use of acylcyclohexanedione derivatives and ethephon.

The present invention therefore relates to the use of at least one compound of the formula I 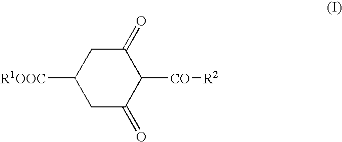
in which
R¹ is H or C₁-C₁₀-alkyl and
R² is C₁-C₁₀-alkyl or C₃-C₁₀-cycloalkyl,
   or salts thereof
together with 2-chloroethylphosphonic acid (ethephon), of the formula II 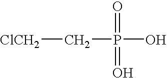
   for the treatment of pome fruit, in particular for preventing the reduced floral development which is observed in pome fruit owing to treatment with acylcyclohexanedione derivatives of the formula I, and for preventing biennial bearing which may be induced by the treatment.

Pome fruit, for the purposes of the present invention is understood as meaning apples, pears or quinces, in particular apples or pears. The term pome fruit, or specified as apples, pears or quinces, refers to the fruit trees or plant parts thereof, but not to the fruits in harvested form.

The treatment is carried out in order to improve floral development in pome fruit. The improvement of floral development encompasses in particular complete or at least partial prevention of the reduced floral development which can be attributed to treatment with acylcyclohexanedione derivatives. At the same time, the treatment should naturally lead to reduced vegetative growth. “Complete or partial prevention of reduced floral development” means that, at a particular point in time or over the entire flowering season, plants treated in accordance with the invention have preferably at least 40%, especially preferably at least 60% and in particular at least 80% of the number of flowers, or, alternatively, the number of inflorescences, of untreated control plants, i.e. control plants which have not been treated with growth regulators but exposed to otherwise identical conditions. The inflorescence is part of the shoot system of a number of Spermatophytes, such as pome fruit, which, as a rule, bears a multiplicity of flowers and later produces one or more fruits.

Partial or complete prevention of reduced floral development also exists when the plants which have been treated in accordance with the invention have, at a particular point in time or over the entire flowering season, significantly more flowers or, alternatively, inflorescences than plants which have been exposed to otherwise identical conditions but which have been treated exclusively with acylcyclohexanedione derivatives, i.e. without ethephon.

Acylcyclohexanedione compounds of the formula I are disclosed in EP-A 0 123 001 and EP-A 126 713.

The compounds of the formula I can be present not only in the trione form (triketo form) I.a, but also in the tautomeric keto-enol forms I.b and I.c, respectively:

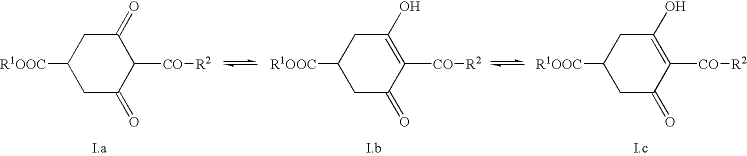

In the compounds of the formula I, R′ is preferably H or C₁-C₄-alkyl.

R² preferably represents C₁-C₄-alkyl or C₃-C₆-cycloalkyl and in particular ethyl or cyclopropyl.

In the definition of the radicals R¹ and R², C₁-C₁₀-alkyl is a linear or branched alkyl radical such as methyl, ethyl, propyl, isopropyl, n-butyl, sec-butyl, isobutyl, tert-butyl, pentyl, neopentyl, hexyl, heptyl, octyl, 2-ethylhexyl, nonyl or decyl. C₁-C₄-alkyl is, for example, methyl, ethyl, propyl, isopropyl, n-butyl, sec-butyl, isobutyl or tert-butyl. The alkyl radical is preferably linear.

In the definition of R², C₃-C₁₀-cycloalkyl is, for example, cyclopropyl, cyclopentyl, cyclohexyl, cycloheptyl, cyclooctyl, cyclodecyl or decalin. C₃-C₆-cycloalkyl is, for example, cyclopropyl, cyclopentyl or cyclohexyl.

The salts of the acylcyclohexanedione compounds I where R¹≠H are the salts of monoanions, while in the case of R¹=H they may be the salts of the monoanions and of the dianions of these compounds. The monoanions can be present both as carboxylate anions I.d and as enolate anions I.e and I.f:

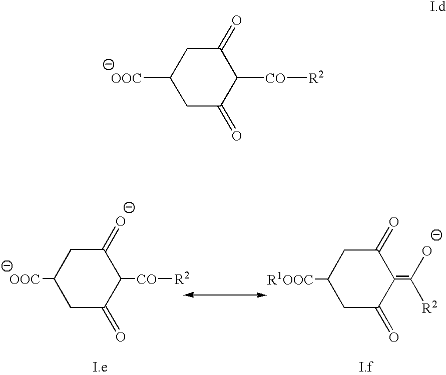

Accordingly, the carboxylate and enolate groups are present together in the dianion.

Preferred cations in the salts of the compounds of the formula I are the ions of the alkali metals, preferably of lithium, sodium and potassium, of the alkaline earth metals, preferably of calcium and magnesium, and of the transition metals, preferably of manganese, copper, zinc and iron, furthermore ammonium (NH₄⁺) and substituted ammonium where one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diisopropylammonium, trimethylammonium, tetrame-thylammonium, tetraethylammonium, tetrabutylammonium, 2-hydroxyethylammonium, 2-(2-hydroxyeth-1-oxy)eth-1-ylammonium, di(2-hydroxyeth-1-yl)ammonium, benzyltrimethylammonium, benzyltriethylammonium, moreover phosphonium ions, sulfonium ions, preferably tri(C₁-C₄-alkyl)sulfonium such as trimethylsulfonium and sulfoxonium ions, preferably tri(C₁-C₄-alkyl)sulfoxonium. Preferred cations are furthermore chlormequat [(2-chloroethyl)trimethylammonium], mepiquat (N,N-dimethylpiperidinium) and N,N-dimethylmorpholinium. Especially preferred cations are the alkali metal cations, the alkaline earth metal cations and the ammonium cation (NH₄⁺). In particular, the salt is the calcium salt.

For the purposes of the present invention, the term “compounds of the formula I” or “acylcyclohexanedione of the formula I” refers both to the neutral compounds I and to their salts.

Compounds I which are especially preferably used in accordance with the invention are prohexadione (R¹=H, R²=ethyl), prohexadione-calcium (the calcium salt of prohexadione), trinexapac (R¹=H, R²=cyclopropyl) and trinexapac-ethyl (R¹=ethyl, R¹=cyclopropyl).

Pome fruit is preferably treated in such a way that the pome fruit tree, or plant parts thereof, is/are brought into contact with at least one acylcyclohexanedione compound I and ethephon. The compounds of the formula I and ethephon can be applied as mixture or separately. In the case of separate application, the individual active substances can be applied simultaneously or one after the other, preferably at an interval of from a few hours up to several weeks in the case of successive application.

The compounds I and ethephon are employed in a weight ratio of preferably from 10:1 to 1:5, especially preferably from 5:1 to 1:3, in particular of from 3:1 to 1:2.

The compounds of the formula I or their salts are preferably employed at an application rate of from 25 to 1500 g/ha, especially preferably from 50 to 1000 g/ha, per season. Prohexadione-calcium is employed in particular at an application rate of from 100 to 500 g/ha per season. Trinexapac-ethyl is employed at an application rate of, in particular, from 200 to 800 g/ha per season. Ethephon is preferably employed at an application rate of from 25 to 1500 g/ha, especially preferably from 50 to 750 g/ha and in particular from 100 to 500 g/ha per season.

The active substances are preferably applied 1 to 5 times, especially preferably 1 to 4 times and in particular 2 to 3 times per season.

It is possible to employ the compound of the formula I together with ethephon in some of the applications only, and to use only one of the active substances, in particular the compound I, in the remaining applications. Preferably, both compound I and ethephon are used in at least half of the applications per season, especially preferably in half of the applications per season and in particular in at least one application.

The application timing, the number of applications and the application rates employed in each case depend on the fruit crop in question and on other parameters such as species and variety of the fruit, rootstock, age, weather conditions, availability of water and nutrients, and must be specified in each individual case by the skilled worker.

Application is preferably effected in spring to early summer (approximately beginning of March to end of July) in the northern hemisphere and, accordingly, from the beginning of September to the end of January in the southern hemisphere. In particular, the treatment is effected when the new shoots start to grow anew, a point in time which generally correlates with the end of flowering or near this point in time, i.e. within ±4 weeks. Further treatments can then follow within a period of up to 10 weeks, for example within 1 to 10 weeks after the first application. The timing of the treatment depends on the requirements of the crop plants in question, which may vary from season to season, depending on the weather conditions and the conditions of the location. However, the skilled worker will be able to determine the treatment timings in the customary manner, and, as a rule, even treatment timings outside the intervals detailed herein are successful and may be meaningful, depending on the requirement of the crop plant.

The compounds of the formula I, ethephon or their mixture are typically employed as formulations as are customary in the field of crop protection.

In the form of concentrated solutions, suspensions or emulsions, for example, they can be diluted with water and applied by spraying. The type of application depends on the species and the variety of the pome fruit and on the plant part to which the mixtures are to be applied; in any case, they should ensure as fine as possible a distribution of the active ingredients and adjuvants.

In addition to the compounds of the formula I and/or ethephon, the formulations may comprise formulation auxiliaries which are conventionally used in the art of crop protection products, for example inert adjuvants and/or surface-active substances such as emulsifiers, dispersants, wetters and the like.

Suitable surface-active substances are the alkali metal salts, alkaline earth metal salts and ammonium salts of aromatic sulfonic acids, for example ligninsulfonic acid, phenolsulfonic acid, naphthalenesulfonic acid and dibutyinaphthalenesulfonic acid, and of fatty acids, alkylsulfonates and alkylarylsulfonates, alkyl sulfates, lauryl ether sulfates and fatty alcohol sulfates, and salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenyl ether, ethoxylated isooctyl-, octyl- or nonylphenol, alkylphenyl ethers, tributylphenyl polyglycol ether, alkylaryl polyether alcohols, isotridecyl alcohol, fatty alcohol/ethylene oxide condensates, ethoxylated castor oil, polyoxyethylene or polyoxypropylene alkyl ethers, lauryl alcohol polyglycol ether acetate, sorbitol esters, lignin-sulfite waste liquors, methylcellulose or siloxanes. Examples of suitable siloxanes are polyether/polymethylsiloxane copolymers, which are also referred to as spreaders or penetrants.

Inert formulation auxiliaries which are suitable are essentially: mineral oil fractions of medium to high boiling point such as kerosine and diesel oil, furthermore coal tar oils and oils of vegetable or animal origin, aliphatic, cyclic and aromatic hydrocarbons, for example paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, for example amines such as N-methylpyrrolidone, and water.

Aqueous use forms of the compounds I, of ethephon or of their mixture can be prepared from stock formulations such as emulsion concentrates, suspensions, pastes, wettable powders or water-dispersible granules by addition of water. To prepare emulsions, pastes or oil dispersions, the compounds of the formula I or ethephon or their mixture, as such or in an oil or solvent, can be dissolved and homogenized in water by means of wetter, sticker, dispersant or emulsifier. Naturally, the use forms will comprise the adjuvants used in the stock formulations.

In a preferred embodiment, the compounds of the formula I, ethephon or their mixture are used in the form of an aqueous spray mixture. This spray mixture comprises the compounds of the formula I or ethephon in an amount of preferably in each case from 25 to 500 ppm. If the compounds of the formula I and ethephon are employed as a mixture, the spray mixture comprises the active substances in a total amount of from preferably 50 to 1000 ppm.

The active ingredient combination of acylcyclohexanediones I and ethephon which is used in accordance with the invention can be used for application in all of the abovementioned pome fruit species, but also in other plant species. Depending on the plant part to which it is to be applied, it can be applied using equipment which is known per se and conventionally used in agricultural practice, application in the form of an aqueous spray solution or spray mixture being preferred.

Application is preferably effected by spraying to run-off point. In this context, the mixture is applied either to all of the aerial plant part or else only to individual plant parts such as flowers, leaves or individual shoots. The choice of the individual plant parts which are to be treated depends on the plant species and its developmental stage. Preferably, all of the aerial part of the plant is treated.

Another subject matter of the present invention is a method for the treatment of pome fruit, which comprises applying at least one compound of the formula I and 2-chloroethylphosphonic acid (ethephon), as a mixture or separately, to pome fruit plants or parts of pome fruit plants in the form of an aqueous spray mixture either simultaneously or in succession.

The method is preferably employed for improving floral development.

What has been said above regarding the compounds of the formula I and ethephon, the aqueous composition and the application also applies analogously here.

The flowering behavior of perennial pome fruit cultures in the year after the treatment is markedly improved by the use according to the invention of acylcyclohexanedione compounds I together with ethephon. In particular, the reduced floral development, which can be attributed to the treatment with certain acylcyclohexanedione derivatives, is essentially prevented. The desired growth regulation takes place simultaneously in the treated plants.

The following examples are intended to illustrate the invention, but without imposing a limitation.

### EXAMPLES

1. Flowering Behavior in Pears after Treatment with Prohexadione-calcium and Ethephon

12-year-old pear trees cv. “Conference” on BA rootstock at two different locations were treated first with prohexadione-calcium alone and secondly with a combination of prohexadione-calcium and ethephon. To this end, 4 groups of 5 trees each, which were uniformly distributed in an orchard, were sprayed with an active-ingredient-comprising spray mixture to run-off point (approx. 1000 l/ha). Three applications at intervals of approximately one month were carried out at the first location. At the second location, prohexadione-calcium was applied four times to a part of the groups of trees and three times to another part, the application interval being in each case approximately two weeks. The combination of prohexadione-calcium and ethephon was applied twice, with in each case one application with prohexadione-calcium alone being carried out before and after the combined application. Approximately one year after the first application, the number of inflorescences of untreated trees, of those which have been treated exclusively with prohexadione-calcium and of trees which had been treated with a combination of prohexadione-calcium and ethephon were counted and compared with each other. The results are listed in Tables 1 and 2 hereinbelow.

TABLE 1
Location 1

| | Application timings 2002 and | | | | Flowering in the |
|---|---|---|---|---|---|
| | application rates of active | | | | subsequent year |
| | substance [g/ha] | | | Total | [number of |
| | 15th | 14th | 16th | rate | inflorescences/tree] |
| Treatment | April | May | June | [g/ha] | April 2003 |
| Untreated | — | — | — | — | 183 |
| ProCa* | 150 | 150 | 150 | 450 | 137 |
| ProCa* + | 150 | 150 | 150 | 450 | 185 |
| ethephon | 120 | 120 | 120 | 360 | |

TABLE 2
Location 2

| | Application timings 2002 and | | | | | Flowering in the |
|---|---|---|---|---|---|---|
| | application rates of active | | | | | subsequent year |
| | substance [g/ha] | | | | Total | [number of |
| | 12th | 3rd | 15th | 30th | rate | inflorescences/tree] |
| Treatment | April | May | May | May | [g/ha] | April 2003 |
| Untreated | — | — | — | — | — | 250 |
| ProCa* | 120 | 87 | 87 | 95 | 389 | 157 |
| ProCa* | 120 | 87 | 87 | — | 294 | 152 |
| ProCa* + | 120 | 110 | 92 | 95 | 417 | 217 |
| ethephon | — | 395 | 315 | — | 710 | |

*Prohexadione-calcium

As can be seen from the above experimental results, the application of prohexadione-calcium leads to reduced floral development in the year following the treatment. If, in contrast, prohexadione-calcium is applied in combination with ethephon, such a reduced floral development is either absent or markedly alleviated.

1-10. (canceled)

11. A method of at least partially preventing reduced floral development of pome fruit plants resulting from applying at least one compound of formula I: 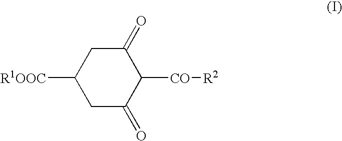
wherein
R¹ is H or C₁-C₁₀-alkyl and
R² is C₁-C₁₀-alkyl or C₃-C₁₀-cycloalkyl,
or salt thereof to said plants or parts thereof, said method comprising also applying 2-chloroethylphosphonic acid (ethephon), as a mixture with said compound or salt thereof or separately, to said plants or parts thereof.

12. The method of claim 11, wherein the floral development is improved.

13. The method of claim 11, wherein the pome fruit plants are apples or pears.

14. The method of claim 11, wherein in the compound of formula I, R¹ is H and R² is ethyl, and the compound of formula I is present in the form of the calcium salt.

15. The method of claim 11, wherein in the compound of the formula I or salt thereof, R¹ is ethyl and R² is cyclopropyl.

16. The method of claim 11, wherein the compound of formula I or salt thereof and 2-chloroethylphosphonic acid are employed in a weight ratio of from 10:1 to 1:5.

17. The method of claim 16, wherein the compound of formula I or salt thereof and 2-chloroethylphosphonic acid are employed as a mixture in the form of an aqueous spray mixture in which the compound of formula I or salt thereof and 2-chloroethylphosphonic acid are present in a total amount of from 50 to 1000 ppm.

18. The method of claim 16, wherein the application rate of the compound of the formula I or salt thereof and of 2-chloroethylphosphonic acid is in the range of from in each case 25 to 1500 g/ha per season.

19. A method for the treatment of pome fruit, comprising applying (a) at least one compound of formula (I): 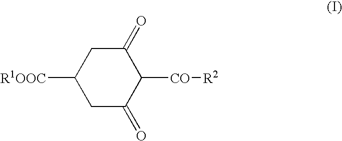
wherein
R¹ is H or C₁-C₁₀-alkyl and
R² is C₁-C₁₀-alkyl or C₃-C₁₀-cycloalkyl,
or salt thereof and (b) 2-chloroethylphosphonic acid, as a mixture or separately, to pome fruit plants or parts of pome fruit plants in the form of an aqueous spray, either simultaneously or in succession.

20. The method of claim 19, wherein the method improves floral development of the pome fruit plants.

21. The method of claim 19, wherein R¹ is H or C₁-C₄-alkyl.

22. The method of claim 19, wherein R² is C₁-C₄-alkyl or C₃-C₆-cycloalkyl.

23. The method of claim 19, wherein the compound of formula (I) or salt thereof is prohexadione, prohexadione-calcium, trinexapac or trinexapac-ethyl.

24. The method of claim 19, wherein the compound of formula I or salt thereof and 2-chloroethylphosphonic acid are employed in a weight ratio of from 10:1 to 1:5

25. The method of claim 19, wherein the compound of formula (I) or salt thereof, and 2-chloroethylphosphonic acid (ethephon), are each applied at the application rate of 25 to 1500 g/ha per season.

26. The method of claim 25, wherein the active substances are applied 1 to 5 times per season

27. The method of claim 19, wherein the pome fruit plants are apples or pears.

28. The method of claim 19, wherein the aqueous spray is applied to the aerial part of the plants to the run-off point.
